(19) United States
(12) Patent Application Publication
(10) Pub. No.: US 2006/0095277 A1
(43) Pub. Date: May 4, 2006

(54) Tracking system

(76) Inventors: Eric D. Noonan, Nashua, NH (US); Spyros Saucier, Tyngsboro, MA (US); John McCarthy, Middleton, MA (US)

Correspondence Address: LAMBERT & ASSOCIATES, P.L.L.C., 92 STATE STREET, BOSTON, MA, 02109-2004, US

(21) Appl. No.: 10/976,535

(22) Filed: Oct. 29, 2004

(51) Int. Cl. G06Q 99/00

(52) U.S. Cl. 705/1

(57) ABSTRACT

Provided is a tracking system preferably utilized to track bus passengers as they travel. Identifying information is contained in cards carried by the passengers, and scanned upon entry or exit of a bus. The information may be transmitted to a base station and validated in real time to ensure that all passengers arrive at the appropriate destinations.

### BACKGROUND OF THE INVENTION

1. Field of the Invention

This invention relates generally to the field of tracking the movements of items, and more particularly to a real time vehicle passenger tracking system.

2. Description of the Related Art

A variety of systems and devices have been devised to track the location and movements of items and people. The purpose of a number of these systems is to ensure that a particular item arrives safely at its intended destination. Some of these systems are designed to do nothing more than ensure that a vehicle passenger is not inadvertently locked within a vehicle, while others are designed to track a person's whereabouts throughout a trip.

The main intent of these systems is for the safety of those being tracked. In the case of a tourism style trip, the passengers are generally unfamiliar with their destinations and it would be inconvenient, and most likely dangerous should they be left behind. In the situation where children are traveling by bus, the number of children and accompanying confusion creates a scenario where it would be very easy for a child to be overlooked and left at an incorrect destination, or forgotten on the vehicle itself at the end of the trip. These situations are no doubt very frightening and possibly very dangerous to a child.

As mentioned, a variety of solutions have been proposed to track passengers, including children, in attempts to alleviate these problems. For example, the patent issued to Lowe, U.S. Pat. No. 5,874,891 discloses a bus alarm that is wired into the bus' existing system, and allows the driver to make a passenger check at various times, not solely when the bus is finally shut down. Additionally, the system allows for test operating emergency exits in conjunction with the passenger check. The alarm could only be deactivated after the check concluded in the rear of the vehicle.

Additionally, Tuttle, U.S. Pat. No. 6,127,917 discloses a system for locating airline passengers in a terminal. Each passenger is given an individual wireless transponder, and the airline facility is equipped with a number of selectively addressable antennas, so that when a specific passenger is needed, the airline can determine where in the airport the passenger is located. Location of the passenger is accomplished by identifying which of the antennas were able to communicate with the transponder carried by the passenger.

The patent issued to Sehr, U.S. Pat. No. 6,609,659 discloses a passenger system that includes travel cards designed to hold various types and amounts of data. Passengers may purchase items and make travel arrangements via the travel cards in addition to identifying themselves when requires to do so. Also, luggage information may be stored and linked to the passenger data on the card. This linkage provides a means for ensuring a one to one match with luggage and passenger, ensuring that all luggage, and passengers, are accounted for. Modules used to read the cards may also communicate in real-time to remote databases containing government or law enforcement data.

Further, Talbot, U.S. Pat. No. 6,667,686 discloses a wireless alarm system for ensuring a driver checks a bus for passengers after the last stop. A transmitter and receiver are located at the front and rear of the bus and interact through a series of alarm sequences. As a back-up to the driver manually checking for passengers, a motion sensor and alarm may also be utilized ensuring that a driver has not simply overlooked a small child.

McDonald, et al., U.S. Pat. No. 6,736,317 discloses a transit system that is internet based and used in real time. The system transmits the identity of passengers to a base station which then cross checks the identifying information with the individuals account data. The appropriate financial transactions take place electronically and in real time. Various other operation may take place within the system, such as those related to the condition of the bus, transit times, driver initiated messages, and the like.

Also, Gupta, et al., U.S. Pat. No. 6,759,972 discloses a fairly simple device designed to ensure that tour group passengers do not miss the scheduled departure of their tour vehicle. Passengers receive a device that is in communication with a transmitter such that an individual passenger may receive a message indicating that it is time to return to the tour vehicle. Collecting the devices upon the passengers' return ensures that none of them are left behind.

Therefore, what is desired is a tracking system that ensures passengers board and depart from the appropriate vehicle at the appropriate time.

Further, it is desired that the tracking system make passenger data, bus and route data, and chronological data available to a dispatcher in real time.

It is also desired that the tracking system be validated and updated in real time.

### BRIEF SUMMARY OF THE INVENTION

Accordingly, it is an object of the present invention to provide a means for tracking passengers in real time that does not impede or slow down the normal operations of providing vehicle transportation.

It is also an object of the present invention to provide a means for storing and transmitting vehicle and route information with a central base station to efficiently monitor vehicle operations.

It is also an object of the invention to provide validation of passenger data, matching it with the appropriate vehicle.

It is a further object of the present invention to provide a means for dynamically changing and updating tracking data to ensure the most up to date information.

### BRIEF DESCRIPTION OF THE DRAWINGS

These and other features, aspects and advantages of the present invention will become better understood with reference to the following description, appended claims, and accompanying drawings where:

FIG. 1 is a flow chart illustrating the process that occurs when a passenger enters or exits the vehicle.

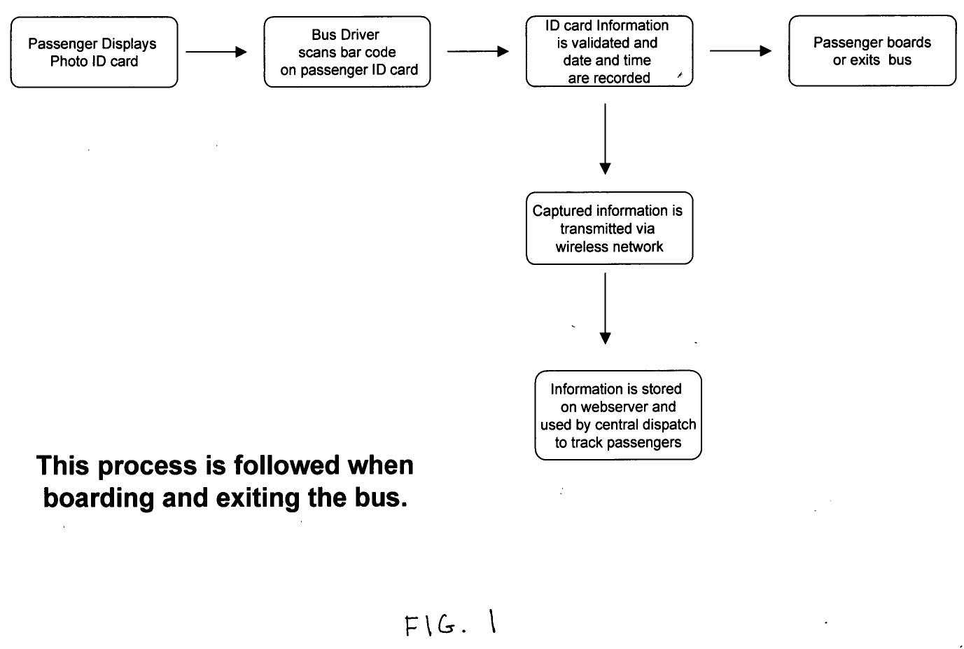

FIG. 2 is an illustration of a base station in wireless communication with a plurality of vehicles.

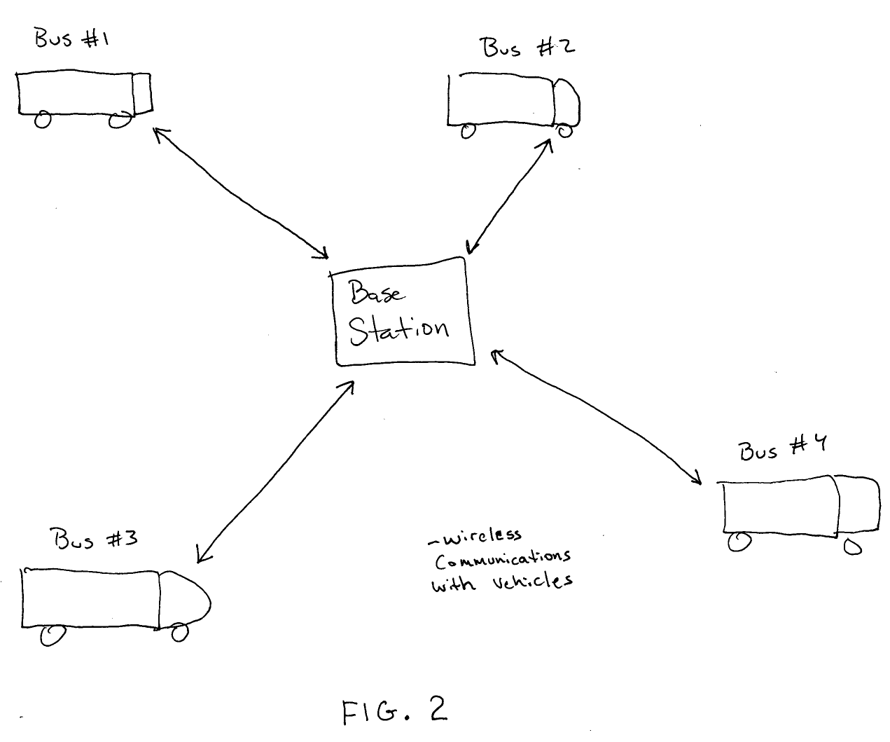

### DETAILED DESCRIPTION OF THE INVENTION

The present invention is designed to track, in real time, items by means of an identifying device, a processor, and a base station. The identifying device of the present invention can be in the form of a card or badge. In the preferred embodiment, the items being tracked are actually passengers on a vehicle, such as a bus. The identifying device may include any form of machine readable portion, such as bar coding, magnetic strips and the like. The identifying device may also include a machine readable portion that interacts by means of being in a certain proximity with the processor, that is, the device reading the information. This type of proximity-style machine readable portion is known to those of ordinary skill in the art, and is similar to so-called “fast passes” and such that are used in a variety of applications. In addition, the identifying device could comprise, or be a part of another device, such as a pager, cell phone or the like.

The processor may be hard-wired, or mounted within the vehicle, or may be a non-mounted, hand held type of device. If the identifying device carried by the passenger include a bar code or stripe, the identifying device is swiped, or scanned by the processor as the passenger boards the vehicle. Assuming that the passenger is boarding the appropriate vehicle, this process is virtually seamless, and consumes little to no time. When the processor reads the identifying information from the card or badge, it is stored locally, and then transmitted to a base station, or is transmitted directly. The processor may also include GPS capability to assist in determining its location. Although preferably stationed within a vehicle, the processors could be utilized within a fixed location, such as a building like a school, whereby students would have their identifying devices read upon entry or exit from the school, or any desired location therein.

The base station and the local processor validates the identifying information based on data already stored therein. The validation could also occur solely within either the base station or local processor. The data transmitted may include the identifying information for the passenger, plus unique identifiers that will distinguish the vehicle, the route, and also time and date. Other data may also be transmitted or stored, such as passenger history, financial data for payment purposes, etc.

If upon validation, the base station determines that the passenger is boarding the wrong vehicle, an alert is issued. The alert may be generated from either the processor, or the base station, depending upon the particular embodiment. The alert is communicated to the operator of the vehicle by means of audio and/or visual display methods. The vehicle operator may also receive information as to the appropriate vehicle for the particular passenger, and may then inform the passenger of this information.

The transmission means utilized in the present invention is preferably of the wireless variety, and may utilize any of a number of wireless transmission means as are known to those of ordinary skill in the art. For example, Bluetooth® GSM/GPRS and 802.11b,g are examples of various wireless protocols that may be utilized. The requirement for the transmission is that it be in real time, and that it be capable of being dynamically updated and transmitted to a desired processor. This capability allows changes to be made and transmitted back to a vehicle operator while in transit, as they are made.

Another component of the preferred embodiment is that the base station is capable of tracking, and communicating with a plurality of vehicles, processors and passengers concurrently. It is also within the scope of the present invention to include more than one physical base station, that is networked or federated in such a way so as to increase response times. Further, all data transmission may be encrypted to ensure privacy and data integrity.

Although the present invention has been described with reference to particular embodiments, it will be apparent to those skilled in the art that variations and modifications can be substituted therefore without departing from the principles and spirit of the invention.

What is claimed is:

1. A tracking system comprising:
an identifying device;
a processor, wherein said processor is capable of interacting with said identifying device;
a base station, herein said base station is capable of interacting with said processor.

2. The tracking system of claim 1, wherein said identifying device includes identifying information.

3. The tracking system of claim 2, wherein said processor further comprises an input mechanism, wherein said input mechanism detects said identifying information.

4. The tracking system of claim 3, wherein said processor further comprises a storage portion.

5. The tracking system of claim 4, wherein said processor further comprises a transmitter and wherein said processor further comprises a receiver.

6. The tracking system of claim 5, wherein said transmitter sends data to said base station, and wherein said receiver receives data from said base station.

7. The tracking system of claim 6, further comprising a transportation device, wherein said processor is carried by said transportation device.

8. The tracking system of claim 7, further comprising at least one carrier, wherein said at least one carrier is assigned an identifying device.

9. The tracking system of claim 8, wherein said carrier comprises a passenger.

10. The tracking system of claim 9, wherein said identifying device includes a picture of said passenger.

11. The tracking system of claim 10, wherein said identifying information comprises a magnetic strip.

12. The tracking system of claim 10, wherein said identifying information comprises a bar code.

13. The tracking system of claim 10, wherein said identifying information comprises a proximity identifier.

14. The tracking system of claim 9, wherein said data includes chronological information.

15. The tracking system of claim 14, wherein said data includes a route identifier, and wherein said data includes a transportation device identifier.

16. The tracking system of claim 15, wherein said base station receives and transmits said data in real time.

17. The tracking system of claim 16, further comprising a data validation, wherein said identifying information is verified.

18. The tracking system of claim 17, wherein said data validation results in an alert if verification fails.

19. The tracking system of claim 18, wherein said transportation device is a bus.

20. The tracking system of claim 19, wherein said processor further comprises a hand held device.

21. The tracking system of claim 20 further comprising a plurality of buses and a plurality of students.

22. A tracking system comprising:
a transportation vehicle comprising vehicle information;
a passenger, wherein said passenger utilizes said transportation vehicle;
an identification card, wherein said identification card is assigned to said passenger;
a processor, wherein said processor resides on or within said transportation vehicle, and wherein said processor is capable of reading identifying information residing on or within said identification card; and
at least one base station, wherein said base station is capable of transmitting and receiving said identifying information and said vehicle information in real time.

23. The tracking system of claim 22, wherein said transportation vehicle is a bus.

24. The tracking system of claim 23, wherein said passenger is a student.

25. The tracking system of claim 24, further comprising a plurality of buses, and a plurality of passengers.

26. The tracking system of claim 25, further comprising a data validation, wherein said identifying information is verified.

27. The tracking system of claim 26, wherein said data validation results in an alert if verification fails.

28. The tracking system of claim 27, wherein said identifying information and said vehicle information is dynamically updated.
